(19) United States
(12) Patent Application Publication
(10) Pub. No.: US 2007/0012825 A1
(43) Pub. Date: Jan. 18, 2007

(54) Article for supporting electronic device

(76) Inventor: Ta-Kuang Yeh, Taipei City (TW)

Correspondence Address: HDSL, 4331 STEVENS BATTLE LANE, FAIRFAX, VA, 22033, US

(21) Appl. No.: 11/178,334

(22) Filed: Jul. 12, 2005

(51) Int. Cl. F16M 11/00

(52) U.S. Cl. 248/122.1

(57) ABSTRACT

An article for supporting an electronic device includes a binding base, a swinging arm and an adhesive assembly. The binding base provides the electronic device to be disposed thereon, which includes a connection portion. The connection portion is pivotally connected to one end of the swinging arm, so as to allow the binding base rotating about the swinging arm to an arbitrary degree. The other end of the swinging arm is pivotally connected to the adhesive assembly, so as to allow the swinging arm rotating about the adhesive assembly to an arbitrary degree. In this manner, the user can situate the electronic device to any predetermined position so as to access and watch the electronic device. In addition, the article can securely hold the electronic device, and is readily adjustable. Moreover, the transportation cost of the article can also be reduced significantly.

### BACKGROUND OF THE INVENTION

The present invention relates generally to an article for supporting an electronic device, and more particularly to an article that can support an electronic device to a fixed position such that the user can easily watch and access the electronic device.

The advancement of modern technology has produced many small electronic devices. For example, these small electronic devices includes cellular phone, tablet computer, palm computer or personal digital assistant (PDA). In order to better access and watch the electronic devices, a supporting frame is used to satisfy such a need. For this reason, to develop a supporting flame that can securely position the electronic device and be adjusted easily is an important issue to address.

A conventional article for supporting the electronic device is disclosed in Taiwanese Patent Application No. 92217638, which includes a main body, a covering body, an adhesive assembly, and a binding base. The main body is a stripe made of flexible material, such that the main body can be deform to an arbitrary angle. The main body is surrounded by the covering body, which is injection molded with the main body. The covering body is made of a soft material. In one particular embodiment, the covering body is a snake tube. In addition, the adhesive assembly and the binding base are pivotally connected to two ends of the main body, respectively. The adhesive assembly can be adhered to any wall surface, while the binding base is used to dispose the electronic device thereon.

Even though the conventional article for supporting the electronic device is advantageous in that the main body thereof can be deformed to any arbitrary angle, it still includes the following drawbacks. Since the main body is to support the weight of the binding base and the electronic device, a main body of different radius is required to support an electronic device of a different weight, so as to prevent the electronic device from falling down. In addition, since the main body can have many different radii, the article for supporting the electronic device thus includes a complicated specification, which renders it difficult to deal with the inventory management and the parts management. Further, since the main body is made of aluminum material, which does not allow multiple deformations, the length of the main body will prohibit the reduction of package sizes during transportation. This will significantly increase the cost on transportation.

Accordingly, the inventor of the present invention realized the drawbacks in the conventional art, and developed the present invention that can overcome the drawbacks described above.

### BRIEF SUMMARY OF THE INVENTION

The present invention is to provide an article for supporting an electronic device. By using the article of the present invention, the user can situate the electronic device to any predetermined position so as to access and watch the electronic device. In addition, the article can securely hold the electronic device, and is readily adjustable. Moreover, the transportation cost of the article can also be reduced significantly.

In order to achieve the above and other objectives, the article for supporting an electronic device of the present invention includes a binding base, a swinging arm and an adhesive assembly. The binding base provides the electronic device to be disposed thereon, which includes a connection portion. The connection portion is pivotally connected to one end of the swinging arm, so as to allow the binding base rotating about the swinging arm to an arbitrary degree. The other end of the swinging arm is pivotally connected to the adhesive assembly, so as to allow the swinging arm rotating about the adhesive assembly to an arbitrary degree.

### BRIEF DESCRIPTION OF THE DRAWINGS

FIG. 1 is an explosive view of the present invention.

FIG. 2 is a perspective view of the present invention.

FIG. 3 illustrates the binding base of the present invention being rotated to different angles.

FIG. 4 illustrates the swinging arm of the present invention being rotated to different angles.

FIG. 5 illustrates the article of the present invention is supporting a cellular phone.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

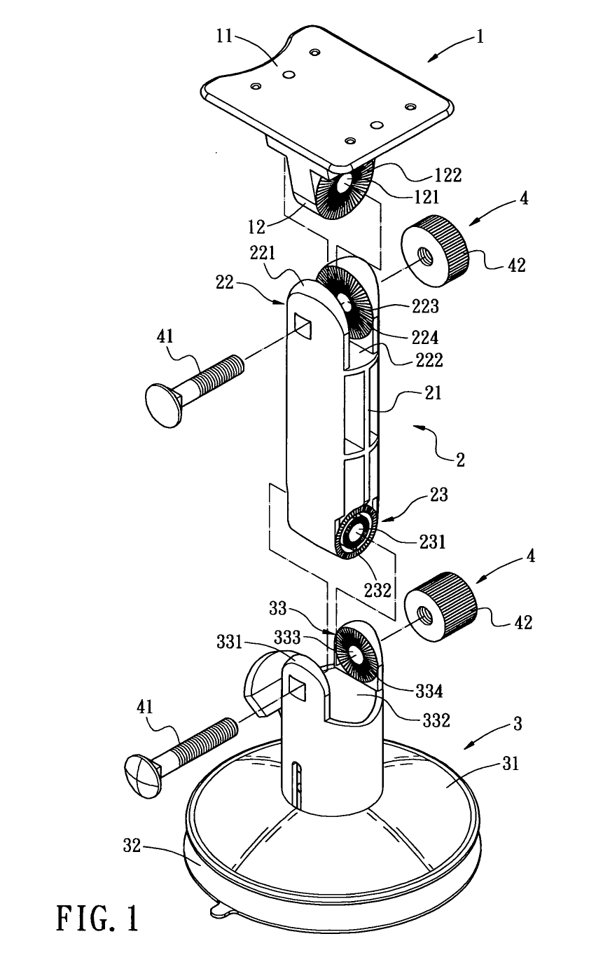

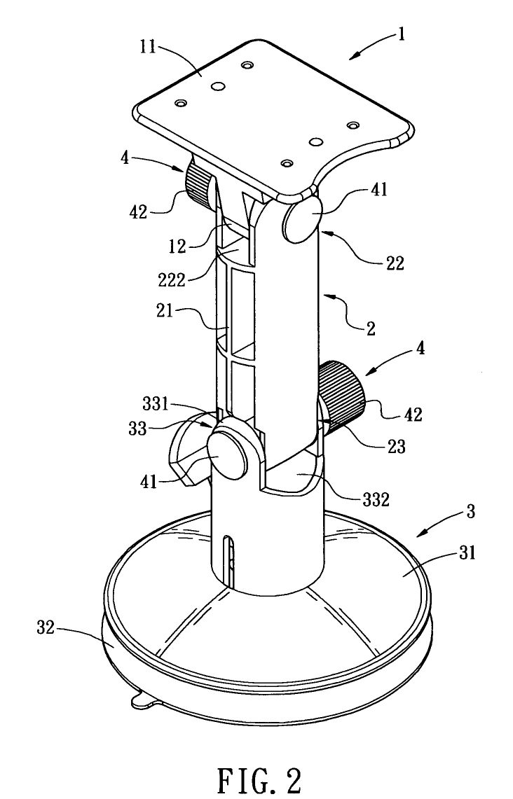

Referring to FIG. 1 and FIG. 2, an explosive view and a perspective view of the present invention are illustrated. The present invention provides an article for supporting an electronic device to securely holding the electronic device in a predetermined position. The article includes a binding base 1, a swinging arm 2 and an adhesive assembly 3.

The binding base 1 includes a flat plate 11 and a connection portion 12 securely connected to the lower portion of the flat plate 11. The flat plate 11 can be made of magnetic material so as to adhere and hold the electronic device. The connection portion can be a block having a through hole 121 formed thereon. A first groove pattern 122 is radiatively formed on two ends of the through hole 121.

The swinging arm 2 includes a rod 21. The upper and lower ends of the rod 21 include a first pivot portion 22 and a second pivot portion 23, respectively. The first pivot portion 22 includes a left and a right supporting frame 221, a retaining groove 222 formed between the two supporting flames 221, and a communicable hole 223 penetrating through the two supporting frames 221. The retaining groove 222 can provide the connection portion 12 of the binding base 1 to retain therein. The communicable hole 223 is disposed corresponding the through hole 121 of the connection portion 12. In addition, a second groove pattern 224 is radiatively formed around the communicable hole 223 and at the inner side of the supporting flames 221. The second groove pattern 224 engages with the first groove pattern 122 of the connection portion 12. When changing the angle of the binding base 1, the engagement of the first groove pattern 122 and the second groove pattern 224 will allow rotations only in steps. The second pivot portion 23 includes a penetrating hole 231. The centerline of the penetrating hole 231 is perpendicular or forming an inclination angle to the centerline of the communicable hole 223. In this particular embodiment, the penetrating hole 231 and the communicable hole 223 are perpendicular to each other. Moreover, a third groove pattern 232 is radiatively formed around the two outer portions of the penetrating hole 231.

The adhesive assembly 3 includes a basis 31 and a sucker 32 connected to the lower portion of the basis 31. The bottom surface of the sucker 32 can be adhered to a concrete wall or a glass surface. The upper portion of the basis 31 includes a connection portion 33. The connection portion 33 includes a left and a right arm 331, a channel groove 332 formed between the two arms 331, and a channel hole 333 penetrating the two arms 331. The channel groove 332 can provide the second pivot portion 23 of the swinging arm 2 to retain therein. The channel hole 333 is disposed corresponding the penetrating hole 231 of the second pivot portion 23. Furthermore, a fourth groove pattern 334 is radiatively formed around the outer portion of the channel hole 333 and at the inner side of the arms 331. The fourth groove pattern 334 engages with the third groove pattern 232 of the second pivot portion 23. When changing the angle of the swinging arm 2, the engagement of the third groove pattern 232 and the fourth groove pattern 334 will allow rotations only in steps.

A fastening element 4 is used to combine the binding base 1, the swinging arm 2 and the adhesive assembly 3. The fastening element 4 includes a threaded rod 41 and a knob 42. First, the threaded rod 41 sequentially penetrates the communicable hole 223 of the swinging arm 2 and the through hole 121 of the binding base 1. The knob 42 is then securely screwed on the threaded rod 41. Second, another threaded rod 41 sequentially penetrates the channel hole 333 of the adhesive assembly 3 and the penetrating holes 231 of the swinging arm 2. Another knob 42 is then securely screwed on the threaded rod 41. This completes the assembly of the article of the present invention.

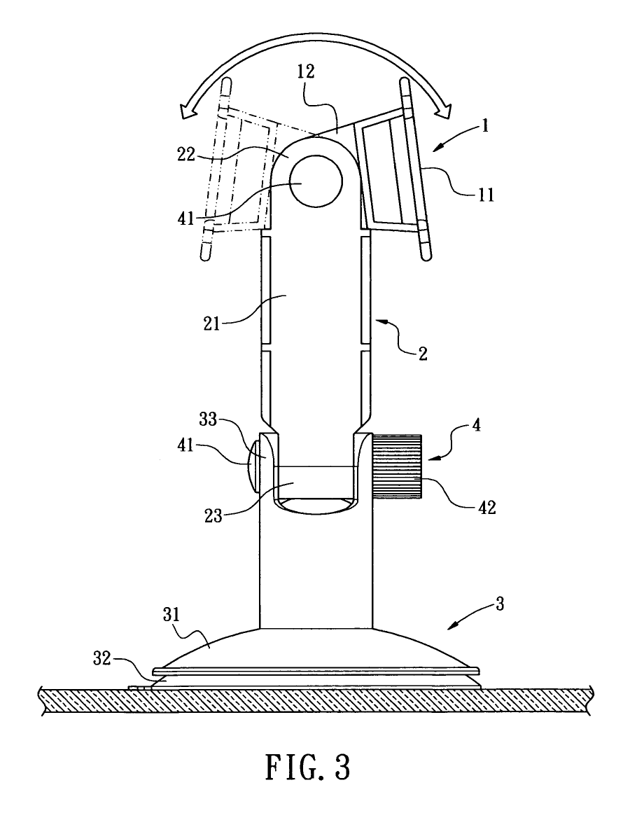

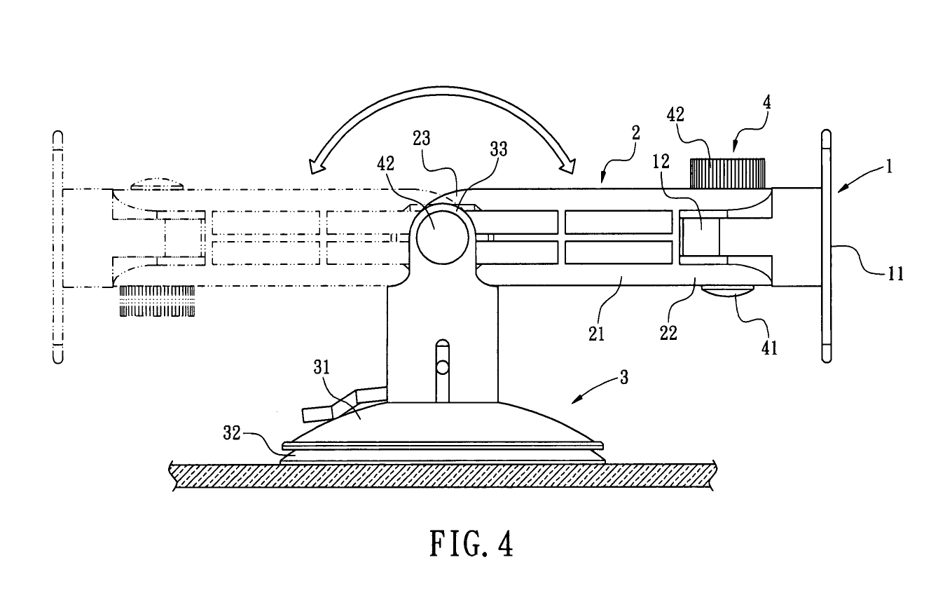

Referring to FIG. 3 and FIG. 4, there are illustrated the binding base and the swinging arm of the present invention being rotated to different angles. The binding base 1 rotates about the first pivot portion 22 of the swinging arm 2. The binding base 1 can be rotated to any arbitrary angle relative to the swinging arm 2 on the same rotation plane, as shown in FIG. 3. On the other hand, the swinging arm 2 rotates about the second pivot portion 23 of the adhesive assembly 3. The swinging arm 2 can be rotated to any arbitrary angle relative to the adhesive assembly 3 on the same rotation plane. Therefore, the binding base 2 can be rotated to any arbitrary angle relative to the adhesive assembly 3.

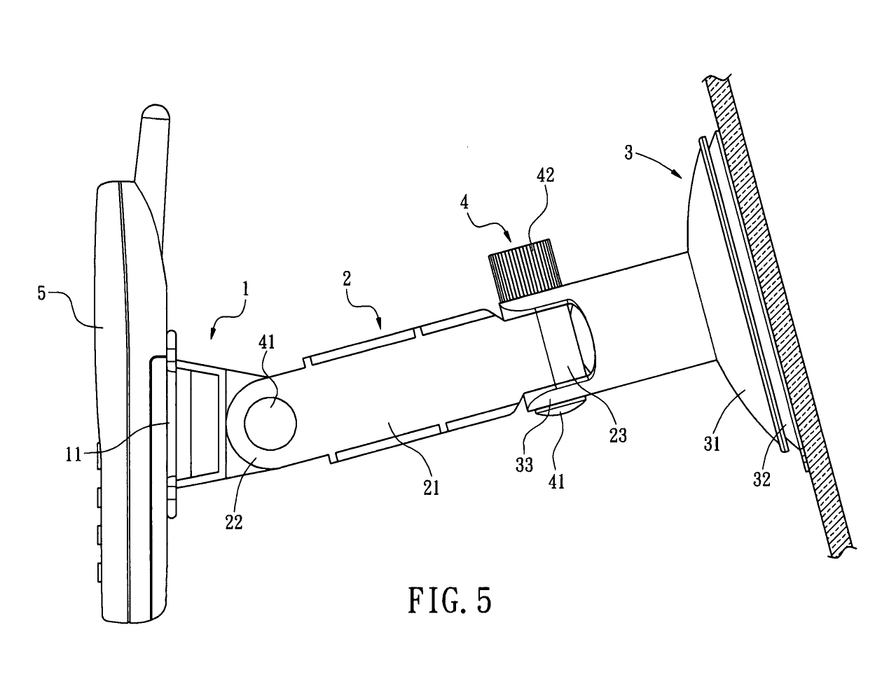

In addition, since it is not necessary to produce the swinging arm 2 from a flexible material, the package size thereof can be reduced significantly. On the other hand, the tightness of the combination of the binding base 1 and the swinging arm 2, or the swinging arm 2 and the adhesive assembly 3 is controlled by the knob 42 of the fastening element 4. Therefore, the article of the present invention can support an electronic device of a wide range of weight (as shown in FIG. 5). The article of the present invention can securely hold the electronic device by properly adjusting the knob 42.

As shown in FIG. 5, the article of the present invention supporting a cellular phone is illustrated. The article for supporting an electronic device of the present invention can support different types of electronic devices. The electronic devices can be a cellular phone, a notebook computer, a tablet computer, a palm computer or a personal digital assistant (PDA). In this particular embodiment, the electronic device is a cellular phone. When using the article of the present invention, the sucker 32 of the adhesive assembly is adhered to a predetermined surface. The angle of the binding base 1 or the swinging arm 2 is adjusted as necessary. The flat plate 11 of the binding base 1 is then situated to a predetermined position or angle. The electronic device 5 is then disposed on the flat plate 11, so as to provide users to access and watch the electronic device 5.

In summary, the present invention indeed satisfies the patentability requirements of the patent law, a grant of letters patent therefor is thus respectfully requested.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. An article for supporting an electronic device, comprising:
a binding base comprising a connection portion, the connection portion having a through hole formed thereon, a first groove pattern being formed on the outer portion of the through hole;
a swinging arm comprising a first pivot portion and a second pivot portion, the first pivot portion including two supporting frames, a retaining groove formed between the two supporting frames, and a communicable hole penetrating the two supporting frames, a second groove pattern being formed on the outer portion of the communicable hole and at the inner side of the supporting frame, the retaining groove providing the connection portion of the binding bade to retain therein and to pivotally connect therewith, the second groove pattern engaging the first groove pattern, thereby allowing the binding base to rotate about the swinging arm to an arbitrary degree, the second pivot portion including a penetrating hole, a third groove pattern being formed on the outer portion of the penetrating hole; and
an adhesive assembly comprising a basis and a sucker connected to the sucker, the basis having a connection portion, which includes two arms, a channel groove formed between the two arms and a channel hole penetrating the two arms, a fourth groove pattern being formed around the outer portion of the channel hole and at the inner side of the arms, the second pivot portion of the swinging arm being retained in and pivotally connected to the channel groove, the fourth groove pattern engaging the third groove pattern, thereby allowing the swinging arm to rotate about the adhesive assembly to an arbitrary degree and position.

2. The article as recited in claim 1, wherein the binding base comprises a flat plate securely disposed on the connection portion, the flat plate being made of magnetic material.

3. The article as recited in claim 1, wherein the centerline of the penetrating hole of the second pivot portion is perpendicular to the centerline of the communicable hole of the first pivot portion.

4. The article as recited in claim 1, wherein the centerline of the penetrating hole of the second pivot portion is forming an inclination angle to the centerline of the communicable hole of the first pivot portion.

5. The article as recited in claim 1, further comprising a fastening element, which combines the binding base and the swinging arm, and another fastening element, which combines the swinging arm and the adhesive assembly, the fastening element comprising a threaded rod and a knob.
